(19) United States
(12) Patent Application Publication
(10) Pub. No.: US 2014/0363367 A1
(43) Pub. Date: Dec. 11, 2014

(54) PROCESS FOR MAKING TITANIUM COMPOUNDS

(71) Applicant: E I Du Pont De Nemours And Company, Wilmington, DE (US)

(72) Inventor: SANG-HWAN KIM, Wilmington, DE (US)

(21) Appl. No.: 13/910,230

(22) Filed: Jun. 5, 2013

(51) Int. Cl. C01D 15/02; C01G 23/053

(52) U.S. Cl. CPC C01D 15/02; C01G 23/0536
USPC 423/598; 423/612

(57) ABSTRACT

A process for the preparation of Li₄Ti₅O₁₂ by a novel, low-cost route from titanium tetrachloride is described. In the process disclosed herein, conditions have been discovered which result in the preparation of Li₄Ti₅O₁₂ having a high purity and a high surface area. These properties are useful for good performance in a lithium ion battery.

### TECHNICAL FIELD

The subject matter of this disclosure relates to a process for the preparation of Li₄Ti₅O₁₂ by a novel, low-cost route from titanium tetrachloride.

### BACKGROUND

Lithium ion batteries (LIBs) have many current and potential uses, including grid-scale energy storage and transportation (e.g. hybrid electric vehicles, electric vehicles and electric trains).

There has been a number of battery systems developed for energy storage needs. LIBs are well-suited for this purpose in terms of performance (round-trip efficiency, life time, and ease of use) when compared with other alternatives such as molten salt batteries and advanced lead-acid batteries. The major factors in technology choice for grid-scale energy storage are cost, lifetime, and safety. Lithium titanate (LTO) anodes, specifically, Li₄Ti₅O₁₂, have been shown to offer several advantages for use in lithium ion batteries, including a long life time and safe operation owing to the materials of construction and the absence of electrochemical decomposition of the electrolyte at the electrode surface.

Methods for preparing LTO are known in the art. For example, a widely used method to prepare LTO is the solid-state reaction of TiO₂ with lithium carbonate.

Another method known in the art is based on the use of TiCl₄ in an HCl solution containing LiCl. The solution is spray dried to yield a solid that contains rutile and a Li salt; there is no reaction between the two materials in the mixture at this point. The mixture is calcined at about 800-1000° C. to generate LTO. The LTO then goes through repeated grinding and additional calcining steps to achieve nano-sized particles.

Similar methods have been described to prepare LTO that involve addition of TiCl₄ to an aqueous solution followed by neutralization of by-product HCl with ammonia. Titanium dioxide as anatase is generated in this step. This titanium dioxide is mixed with LiOH and is then spray dried to yield particles of desired sized. Calcination under nitrogen and then under ambient atmosphere yields LTO.

Additionally, Thompson (WO 2011/146838 A2) describes a process for preparing LTO which comprises hydrolyzing TiCl₄ to provide titanium oxychloride, which is then hydrolyzed to yield titanium dioxide. The titanium dioxide is mixed with a lithium salt to give LTO.

Methods to prepare high purity titanium dioxide having controlled particle size, which can be used to prepare LTO, are also known in the art (e.g., Lawhorne, U.S. Pat. No. 4,944,936) and Roberts et al., U.S. Pat. No. 4,923,682)

Because the cost for materials is the largest cost component in LIB manufacture, the use of low-cost materials will offer a significant commercial advantage. A need thus remains for a simple, streamlined preparation of LTO having useful properties (such as high purity and a high surface area) for LIB applications by a process that uses inexpensive reagents.

### SUMMARY

In one embodiment, there is provided herein a process for preparing Li₄Ti₅O₁₂, comprising the steps of:
a) hydrolyzing TiCl₄ in an aqueous medium to provide an aqueous solution containing TiOCl₂ at a concentration of about 0.1 M to about 3.0 M;
b) generating a suspension containing hydrated TiO₂ particles by preparing a reaction mixture having a Ti concentration of about 0.05 M to about 2.0 M by adding the aqueous solution containing TiOCl₂ to a volume of a second aqueous medium which is agitated and heated to a temperature of about 60° C. to about 100° C., wherein the aqueous solution containing TiOCl₂ is added to the second aqueous medium at a rate less than 40 mL/L/min; and continuing agitating and heating the reaction mixture at a temperature of about 60° C. to about 100° C. for a period of time sufficient to prepare the suspension containing hydrated TiO₂ particles, wherein the hydrated TiO₂ particles have a median diameter of about 0.1 μm to about 9.0 μm;
c) recovering the hydrated TiO₂ particles from the suspension of step (b);
d) mixing the hydrated TiO₂ particles with a lithium salt to prepare a mixture having a Li to Ti ratio of about 0.6 to about 1.0; and
e) calcining the mixture from step (d) at a temperature of about 750° C. to about 1000° C. for a period of time sufficient to prepare Li₄Ti₅O₁₂.

In another embodiment provided herein, there is provided a process for preparing titanium dioxide, comprising the steps of:
a) hydrolyzing TiCl₄ in an aqueous medium to provide an aqueous solution containing TiOCl₂ at a concentration of about 0.1 M to about 3.0 M;
b) generating a suspension containing hydrated TiO₂ particles by preparing a reaction mixture having a Ti concentration of about 0.05 M to about 2.0 M by adding the aqueous solution containing TiOCl₂ to a volume of a second aqueous medium which is agitated and heated to a temperature of about 60° C. to about 100° C., wherein the aqueous solution containing TiOCl₂ is added to the second aqueous medium at a rate less than 40 mL/L/min; and continuing agitating and heating the reaction mixture at a temperature of about 60° C. to about 100° C. for a period of time sufficient to prepare the suspension containing hydrated TiO₂ particles, wherein the hydrated TiO₂ particles have a median diameter of about 0.1 μm to about 9.0 μm; and
c) recovering the hydrated TiO₂ particles from the suspension of step (b).

### DETAILED DESCRIPTION

Disclosed herein is a process for preparing Li₄Ti₅O₁₂. The process comprises several steps. The first step is the hydrolysis of titanium tetrachloride (TiCl₄) to yield an aqueous solution containing titanium oxychloride (TiOCl₂). The second step, involves the thermal hydrolysis of TiOCl₂ to provide hydrated titanium dioxide, typically in the rutile phase. The first two steps of the process are shown in Equation 1.

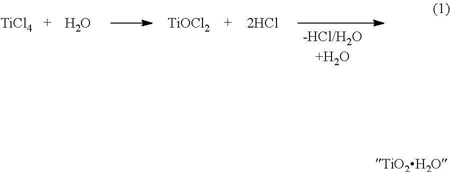

The hydrated titanium dioxide formed is mixed with a lithium salt and the resulting mixture is calcined to yield the Li₄Ti₅O₁₂. For example, the hydrated titanium dioxide can be mixed with Li₂CO₃ and calcined at 800° C., as shown in Equation 2.

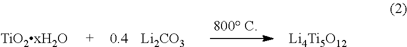

In the process disclosed herein, conditions have been discovered which result in the preparation of Li₄Ti₅O₁₂ having a high purity and a high surface area. These properties are critical for good performance of the Li₄Ti₅O₁₂ as an anode active material in a lithium ion battery. The intermediate titanium dioxide formed in the process also has the advantageous properties recited above and can also be used for other applications.

More specifically, in the first step of the process disclosed herein, TiCl₄ is added to a first aqueous medium with agitation, typically at a rate in the range of about 40 mL/hour to about 60 mL/hour, or a range of about 45 mL/hour to about 55 mL/hour. In one embodiment, the first aqueous medium is water which does not contain additional components or reagents, such as a surfactant or an acid such as HCl. The TiCl₄ is preferably handled under an inert, dry atmosphere until addition is performed. The aqueous medium used in this step can be maintained at a temperature in the range of about −20° C. to about 20° C., or about −5° C. to about 5° C., or at a temperature of about 0° C. This step provides an aqueous solution containing TiOCl₂ at a concentration of about 0.1 M to about 3.0 M, or about 1.0 M to about 2.5 M or about 1.5 M to about 2.0 M, or about 1.8 M. The TiOCl₂ can be isolated by any conventional means, or can also be, and is more typically, used as the aqueous solution in further steps of the process.

In the next step in the process disclosed herein, a suspension containing hydrated TiO₂ particles is generated. To generate the suspension, a reaction mixture is prepared by adding the aqueous solution containing TiOCl₂ from the first step to a volume of a second aqueous medium to give a concentration of Ti in the range of about 0.05 M to about 2.0 M, or about 0.5 M to about 1.5 M, or about 1.0 M. In one embodiment, the second aqueous medium is water which does not contain additional components or reagents, such as a surfactant or an acid such as HCl. During the addition of the aqueous solution containing TiOCl₂, the second aqueous medium is agitated and heated to a temperature of about 60° C. to about 100° C., or about 70° C. to about 100° C., or about 80° C. to about 100° C., or about 90° C. to about 100° C. The second aqueous medium can be agitated using any means known in the art, such as stirring, shaking, ultrasonicating or any combination thereof. The second aqueous medium is agitated at a rate of about 0.15 m/s to about 15 m/s, or about 1 m/s to about 10 m/s, or about 2 m/s to about 8 m/s. In one embodiment, the second aqueous medium is agitated at a rate to give turbulent flow, resulting in a Reynolds number higher than 10000. As known in the art of fluid mechanics, the Reynolds number is a dimensionless number defined as the ratio of dynamic pressure and shearing stress.

The aqueous solution containing TiOCl₂ is added to the second aqueous medium at a rate less than 40 mL/L/min, or about 1.0 mL/L/min to about 30 mL/L/min, or about 1.0 mL/L/min to about 20 mL/L/min, or about 1.0 mL/L/min to about 10 mL/L/min, or about 2.5 mL/L/min to about 5.5 mL/L/min. After completion of the addition of the aqueous solution containing TiOCl₂, the resulting reaction mixture is continued to be heated and agitated, as described above, for a time sufficient to prepare the suspension containing hydrated TiO₂ particles having a particle size of about 0.1 μm to about 9.0 μm. Typically, the reaction medium is heated and agitated for a time of about 10 min to about 360 min, or about 15 min to about 240 min, or about 20 min to about 120 min.

The TiO₂ formed in the second step is typically in rutile phase, or is a mixture of substantially rutile phase with other phases. The TiO₂ can be recovered, typically as a dried solid, using conventional methods such as filtration, centrifugation, decantation, settling, or any combination thereof. Typically the TiO₂ is isolated in a hydrated form. The titanium dioxide referred to herein can thus be crystalline or amorphous TiO₂, or hydrated crystalline or hydrated amorphous TiO₂, or a mixture thereof. The recovered TiO₂ particles can be washed with water to remove the HCl formed in the hydrolysis reaction.

Processes to prepare titanium dioxide can be performed by using the steps as set forth above.

Next, the hydrated TiO₂ particles are mixed with a lithium salt to prepare a mixture having a Li to Ti ratio of about 0.6 to about 1.0, or about 0.7 to about 0.9, or about 0.78 to about 0.82. Suitable lithium salts include without limitation, lithium hydroxide, lithium carbonate, lithium sulfate, lithium phosphate and lithium carboxylates such as lithium formate, lithium acetate, lithium citrate, lithium benzoate, or mixtures thereof. In one embodiment, the lithium salt is lithium carbonate.

Then, the mixture of the hydrated TiO₂ particles and the lithium salt is calcined by heating to a temperature of about 750° C. to about 1,000° C., or about 750° C. to about 900° C., or about 750° C. to about 900° C., or about 800° C. for a time sufficient to prepare Li4Ti5O12. Calcining can be conducted for a time period of at least about 0.5 hours, at least about 1 hours, or at least about 2 hours, and yet no more than about 20 hours, or no more than about 10 hours, or no more than about 6 hours; or a time period in the range of about 0.5 to about 20 hours. Heating can be conducted with conventional equipment such as an oven.

The process disclosed herein yields LTO particles having a purity greater than 95% and a surface area greater than or equal to 3.0 m²/g, or about 3.0 m²/g to about 10 m²/g. The purity can be determined using X-ray diffraction analysis (XRD). The surface area of the LTO particles can be determined by BET surface analysis.

The LTO produced by the process disclosed herein can be used to fabricate electrodes for use in an electrochemical cell such as a battery. An electrode is prepared by forming a paste from the LTO and a binder material such as a fluorinated (co)polymer (e.g. polyvinylfluoride) by dissolving or dispersing the solids in water or an organic solvent. The paste is coated onto a metal foil, preferably an aluminum or copper foil, which is used as a current collector. The paste is dried, preferably with heat, so that the solid mass is bonded to the metal foil.

The electrode described above can be used to fabricate an electrochemical cell such as a battery. In one embodiment, the battery is a lithium ion battery. An electrode, prepared as described above, is provided as the anode or cathode (usually the anode), and a second electrode is provided by similar preparation from electrically-active materials such as platinum, palladium, electroactive transition metal oxides comprising lithium, or a carbonaceous material including graphite as the other electrode. The two electrodes are layered in a stack but separated therein by a porous separator that serves to prevent short circuiting between the anode and the cathode. The porous separator typically consists of a single-ply or multi-ply sheet of a microporous polymer such as polyethylene, polypropylene, or a combination thereof. The pore size of the porous separator is sufficiently large to permit transport of ions, but small enough to prevent contact of the anode and cathode either directly or from particle penetration or dendrites which can form on the anode and cathode.

The stack can be rolled into an elongated tube form and is assembled in a container with numerous other such stacks that are wired together for current flow. The container is filled with an electrolyte solution, such as a linear or cyclic carbonate, including ethyl methyl carbonate, dimethyl carbonate or diethylcarbonate. The container when sealed forms an electrochemical cell such as a battery.

The electrochemical cell disclosed herein may be used for grid storage or as a power source in various electronically-powered or -assisted devices (“Electronic Device”) such as a transportation device (including a motor vehicle, automobile, truck, bus or airplane), a computer, a telecommunications device, a camera, a radio or a power tool.

### EXAMPLES

The subject matter disclosed herein is further defined in the following examples. It should be understood that these examples, while describing various features of certain particular embodiments of some of the inventions hereof, are given by way of illustration only.

The meaning of abbreviations used in the following examples is as follows: “g” means gram(s), “mg” means milligram(s), “μg” means microgram(s), “L” means liter(s), “mL” means milliliter(s), “mol” means mole(s), “mmol” means millimole(s), “M” means molar concentration, “wt %” means percent by weight, “h” means hour(s), “min” means minute(s), “m” means meter(s), “cm” means centimeter(s), “mm” means millimeter(s), “μm” means micrometer(s), “nm” means nanometer(s), “mils” means thousandths of an inch, “lbs” means pounds, “kN” means kilonewtons, “rpm” means revolutions per minute, “A” means ampere(s), “mA” means milliampere(s), “mAh/g” means milliampere hour(s) per gram, “V” means volt(s), “xC” refers to a constant current which is the product of x and a current in A which is numerically equal to the nominal capacity of the battery expressed in Ah, “XRD” means X-ray diffraction, “TGA” means thermal gravimetric analysis, “SEM” means scanning electron microscopy, “MΩ” means megaohm(s).

### Materials

For the hydrolysis of TiCl₄, highly purified water was obtained from a Sartorius Arium 611DI unit (Sartorius North America Inc., Edgewood, N.Y.) and used to prepare solutions and rinse glassware prior to use. For the single-step thermal hydrolysis of TiOCl₂, deionized water was used. Titanium tetrachloride (Aldrich ReagentPlus®, 99.9%, catalog no. 208566), lithium hydroxide monohydrate (catalog no. 13020), and titanium dioxide (nanopowder, <25 nm particle size, 99.7%, catalog no. 637254) were purchased from Sigma-Aldrich (Milwaukee, Wis.). Lithium carbonate (99%, catalog no. 13418) was obtained from Alfa Aesar (Ward Hill, Mass. 01835).

### Example 1

### Preparation of Hydrated Titanium Dioxide

Hydrated titanium dioxide was prepared by a two-step process. In the first step, titanium oxychloride was prepared by hydrolysis of titanium tetrachloride. In the second step, hydrated titanium dioxide was prepared by thermal hydrolysis of the titanium oxychloride.

### Step 1 Preparation of Titanium Oxychloride (TiOCl₂) Solution:

TiCl₄ was loaded into a 60 mL polypropylene Luer lock syringe in a nitrogen-filled dry box. The syringe was capped and removed from the dry box. Then, the syringe was placed on a syringe pump (KD Scientific, Holliston, Mass.) and was connected to a flexible Luer lock tubing assembly (Hamilton Co., Reno, Nev., catalog no. 90615), which was used for transferring the loaded TiCl₄ into a two-neck 1000 mL round bottom flask containing 400 mL of water and a Teflon®-coated magnetic stir bar. The flask was cooled in an ice-water bath. TiCl₄ was added at a rate of 50 mL/h into the water, which was stirred using the magnetic stir bar. The tip of the tubing was kept above the solution in order to avoid clogging. A colorless, clear solution was formed, which contained 7.67% of titanium, as determined by ICP-AES (inductively coupled plasma-atomic emission spectroscopy). The solution was stored at room temperature in a glass bottle until needed.

### Step 2 Preparation of Hydrated Titanium Dioxide:

TiOCl₂ solution, prepared as described in step 1, was diluted to a concentration of 1.8 M. Deionized water (89 mL) was added to a 500 mL three-neck, round bottom flask, which was placed in the center of a heating mantel. Sand was loaded to fill any gap between the heating mantel and the flask. A Teflon® paddle blade (Chemglass Life Sciences, Vineland, N.J., catalog no. CG-2080-02; ⅛ inch thick, width×length (mm)=19×60) was connected to one end of a shaft and inserted into the flask through the middle neck, which was fitted with a stirrer bearing to fit the shaft. The other end of the shaft was connected to a digital overhead stirrer. An adapter was inserted in one side neck of the flask and two thermocouples were introduced to contact the water through the adaptor. An addition funnel equipped with a Teflon® stopcock was inserted in the other side neck of the flask. The 1.8 M TiOCl₂ solution (111 mL) was loaded in the addition funnel. The water was heated to a temperature of 80° C. and the digital overhead stirrer was set to 1200 rpm. Then, the TiOCl₂ solution was added at a rate of about 5.5 mL/L/min for 100 min. The temperature of the mixture was kept at about 80° C. during the addition. After the addition of the first several drops of the TiOCl₂ solution, the mixture turned milky. After the addition of the TiOCl₂ solution was completed, the mixture was kept at about 80° C. for 20 min. The total reaction time at about 80° C. was 2 h. The resulting white slurry was filtered and the collected precipitate was washed with 1 L of deionized water and then vacuum-dried at room temperature overnight to yield 15.71 g of hydrated titanium dioxide.

XRD analysis of the hydrated titanium dioxide showed the formation of rutile (86.7%) and anatase/brookite (13.3%). The solid product contained 88.75% TiO₂, as determined by TGA. Particle size distribution (PSD) analysis showed that D10, D50, and D90 were 0.65 μm, 0.87 μm, and 1.20 μm, respectively. As used herein, D50 is the median defined as the diameter where half of the population lies above and below this value. Likewise, DX (X=10 and 90) is defined as the diameter where X percent of the population resides below this value and 100−X percent of the population resides above this value. SEM analysis showed that the primary particles were spindle-to-rod shaped having a length of about 100 nm to about 300 nm. The primary particles were aggregated and aligned to form secondary particles whose diameter was in the range of about 0.3 μm to about 1 μm. The surface area was determined to be 109.8 m²/g by BET surface analysis and the pore volume was determined to be 0.1429 cm³/g.

### Example 2

### Preparation of Lithium Titanate

Hydrated TiO₂ (5.000 g), prepared as described in Example 1, and 1.6422 g of Li₂CO₃ were jar-milled with yttrium stabilized zirconia balls (diameter=5 mm). The mixed powders were loaded in an alumina cup and heated at 800° C. for 6 h, resulting in the formation of a white powder. The formation of Li₄Ti₅O₁₂ was confirmed by XRD analysis. The surface area and the pore volume were determined to be 3.7 m²/g and 0.0074 cm³/g, respectively, by BET surface analysis. SEM analysis showed open pores formed by connected polyhedron-to-multipod shaped primary particles, where the particles had a side of length smaller than about 500 nm.

### Example 3

### Preparation of Hydrated Titanium Dioxide

Hydrated titanium dioxide was prepared using the process described in Example 1, except that the temperature was kept at 90° C. The process resulted in the formation of 17.118 g of hydrated titanium dioxide.

XRD analysis of the hydrated titanium dioxide showed the formation of rutile (80.5%) and anatase/brookite (19.5%). The solid product contained 88.8% TiO₂, as determined by TGA. Particle size distribution analysis shows that D10, D50, and D90 were 0.20 μm, 0.30 μm, and 0.41 μm, respectively. SEM analysis showed that the primary particles were spindle-to-rod shaped having a length in the range of about 0.1 μm to about 0.2 μm. The primary particles were aggregated and aligned to form secondary particles whose diameter was in the range of about 0.2 μm to about 0.5 μm. The surface area was determined to be 94.8 m²/g by BET surface analysis and the pore volume was determined to be 0.3559 cm³/g.

### Example 4

### Preparation of Lithium Titanate

Hydrated TiO₂ (6.000 g), prepared as described in Example 3, and 1.9718 g of Li₂CO₃ were jar-milled with yttrium stabilized zirconia balls (dia.=5 mm). The mixed powders were loaded in an alumina cup and heated at 800° C. for 6 h, resulting in the formation of a white powder. The formation of Li₄Ti₅O₁₂ was confirmed by XRD analysis. The surface area was determined to be 2.5 m²/g by BET surface analysis and the pore volume was determined to be 0.006 cm³/g. SEM analysis showed open pores formed by connected polyhedron-to-multipod shaped primary particles.

### Example 5

### Preparation of Hydrated Titanium Dioxide

Hydrated titanium dioxide was prepared using the process described in Example 1, except that a 1000 mL three-neck, round bottom flask was used. Also, a peristaltic pump (Thermo Scientific, Barrington, Ill. model no. FH100) with Masterflex® Tygon® L/S 13® tubing (Cole-Parmer Instrument Co., Vernon Hills, Ill.) was used for adding TiOCl₂ at a rate of about 5.5 mL/L/min in place of the addition funnel. The digital overhead stirrer was set to 100 rpm. The process resulted in the formation of 14.930 g of hydrated titanium dioxide.

The solid product contained 88.94% TiO₂, as determined by TGA. Particle size distribution analysis showed that D10, D50, and D90 were 1.06 μm, 1.92 μm, and 3.39 μm, respectively. SEM analysis showed that the primary particles were spindle-to-rod shaped having a length in the range of about 0.1 μm to about 0.2 μm. The primary particles were aggregated and aligned to form secondary particles whose diameter was in the range of about 0.5 μm to about 2.0 μm. Some of the secondary particles were aggregated to form larger particles up to about 10 μm.

### Example 6

### Preparation of Hydrated Titanium Dioxide

Hydrated titanium dioxide was prepared using the process described in Example 5, except that the addition rate of TiOCl₂ was about 3.55 mL/L/min for about 156 min and the digital overhead stirrer was set to 1200 rpm. The process resulted in the formation of 15.253 g of hydrated titanium dioxide.

The solid product contained 89.04% TiO₂, as determined by TGA. Particle size distribution analysis showed that D10, D50, and D90 were 0.67 μm, 0.91 μm, and 1.26 μm, respectively. SEM analysis showed that the particles had similar size and morphology to the hydrated titanium dioxide described in Example 1.

### Example 7

### Preparation of Lithium Titanate

Hydrated TiO₂ (5.000 g), prepared as described in Example 6, and 1.8898 g of LiOH—H₂O (1 wt % excess amount) were placed in a poly(tetrafluoroethylene)-coated square bottom container. Deionized water (10 mL) and a Teflon®-coated bar were added to the container. The container was heated on a hot plate at 80° C. for 20 min with stirring at 140 rpm. Then, the container was placed in a vacuum oven at 120° C. with nitrogen purging. The dried powders were jar-milled with yttrium stabilized zirconia balls (diameter=5 mm). The mixed powders were placed in an alumina tray and then fired at 800° C. for 2 h in air, resulting in the formation of a white powder. The formation of Li₄Ti₅O₁₂ was confirmed by XRD analysis. The surface area was determined to be 3.6 m²/g by BET surface analysis and the pore volume was determined to be 0.0082 cm³/g.

### Example 8

### Preparation of Hydrated Titanium Dioxide (Larger Scale)

Hydrated titanium dioxide was prepared using the process described in Example 3 except that: 1.8 M TiOCl₂ (444 mL), deionized water (356 mL), a TiOCl₂ addition rate of about 5.5 mL/L/min for 100 min, three-neck round bottom flask (2 L), a Teflon® paddle blade (Chemglass Life Sciences, Vineland, N.J., catalog no. CG-2080-04; ⅛ inch thick, width×length (mm)=24×110), and a peristaltic pump were used. The process resulted in the formation of 72.5712 g of hydrated titanium dioxide.

The solid product contained 90.65% TiO₂, as determined by TGA. Particle size distribution analysis showed that D10, D50, and D90 were 0.19 μm, 0.30 μm, and 0.44 μm, respectively, consistent with the results obtained in Example 3.

### Example 9

### Preparation of Lithium Titanate

Hydrated TiO₂ (10.000 g), prepared as described in Example 8, and 3.3545 g of Li₂CO₃ were placed in a plastic bottle. The mixture was wet-milled with approximately 50 g of Li₂CO₃-saturated deionized water and approximately 110 g of yttrium stabilized zirconia balls (diameter=5 mm). The powders were collected by filtration and dried in a vacuum oven at 120° C. under vacuum. The dried powders were placed in an alumina tray and then fired at 800° C. for 2 h in air, resulting in the formation of a white powder. The formation of Li₄Ti₅O₁₂ was confirmed by XRD analysis. The surface area was determined to be 6.6 m²/g by BET surface analysis and the pore volume was determined to be 0.0241 cm³/g.

### Example 10

### Preparation of Hydrated Titanium Dioxide

Hydrated titanium dioxide was prepared using the same equipment described in Example 5. Deionized water (89.0 mL) was heated to a temperature of 97° C. and the digital overhead stirrer was set to 1200 rpm. Then, 343 mL of 1.8 M TiOCl₂ solution was added at a rate of about 2.55 mL/L/min for 300 min. The temperature of the mixture was kept at about 97° C. during the addition. After the addition of the TiOCl₂ solution was completed, the mixture was kept at about 97° C. for 10 min. The process resulted in the formation of 53.2189 g of hydrated titanium dioxide.

The solid product contained 92.12% TiO₂, as determined by TGA. Particle size distribution analysis showed that D10, D50, and D90 were 0.54 μm, 0.75 μm, and 1.00 μm, respectively. SEM analysis showed that the primary particles were rod-shaped having a length of about 200 nm to about 500 nm with a width of about 50 nm to about 100 nm. The aspect ratio of the primary particles ranged from about 3 to about 6. The primary particles were agglomerated and aligned to form secondary particles whose diameter was in the range of about 0.5 μm to about 1 p.m. The surface area was determined to be 48.3 m²/g by BET surface analysis and the pore volume was determined to be 0.0948 cm³/g.

### Example 11

### Preparation of Lithium Titanate

Hydrated TiO₂ (10.000 g), prepared as described in Example 10, and 3.4089 g of Li₂CO₃ were placed in a plastic bottle. The mixture was wet-milled with approximately 50 g of Li₂CO₃-saturated deionized water and approximately 140 g of yttrium stabilized zirconia balls (diameter=5 mm). The powders were collected by filtration and dried in a vacuum oven at 120° C. under vacuum. The dried powders were placed in an alumina tray and then fired at 800° C. for 2 h in air, resulting in the formation of a white powder. The formation of Li₄Ti₅O₁₂ was confirmed by XRD analysis. The surface area was determined to be 5.9 m²/g by BET surface analysis and the pore volume was determined to be 0.0120 cm³/g.

### Example 12

### Preparation of Hydrated Titanium Dioxide

Hydrated titanium dioxide was prepared using the same process and equipment described in Example 8 except that: 1.8 M TiOCl₂ (222 mL), deionized water (178 mL), and reaction temperature (92° C.) were used. The process resulted in the formation of 32.0738 g of hydrated titanium dioxide.

The solid product contained 93.03% TiO₂, as determined by TGA. Particle size distribution analysis showed that D10, D50, and D90 were 0.18 μm, 0.26 μm, and 0.40 μm, respectively.

### Example 13

### Preparation of Hydrated Titanium Dioxide

Hydrated titanium dioxide was prepared using the same process and equipment described in Example 12 except that: 1.8 M TiOCl₂ (555 mL), deionized water (445 mL), and a three-neck round bottom flask (3 L) were used. The process resulted in the formation of 76.3876 g of hydrated titanium dioxide.

The solid product contained 94.42% TiO₂, as determined by TGA. Particle size distribution analysis showed that D10, D50, and D90 were 0.19 μm, 0.27 μm, and 0.39 μm, respectively.

### Example 14

### Preparation of Lithium Titanate

The hydrated titanium dioxides prepared as described in Examples 12 and 13 (32.0738 g and 76.3876 g, respectively), were combined with 38.9662 g of Li₂CO₃ (3 wt % excess amount) in a plastic bottle. The mixture was vibratory-milled using a SWECO vibratory mill (SWECO, Florence, Ky.) with approximately 500 g of Li₂CO₃-saturated deionized water and approximately 5.5 kg of yttrium stabilized zirconia cylinders (diameter=9.5 mm, height=9.5 mm) for 24 h. The powders were collected by filtration and dried in a vacuum oven at 120° C. under vacuum. The dried powders were placed in an alumina tray and then fired at 800° C. for 1 h in air, resulting in the formation of a white powder. The formation of Li₄Ti₅O₁₂ was confirmed by XRD analysis. The surface area was determined to be 6.0 m²/g by BET surface analysis and the pore volume was determined to be 0.0124 cm³/g.

### Example 15

### Electrochemical Performance of Lithium Titanates

The electrochemical performance of various lithium titanates was evaluated in coin cells with half-cell configuration.

Preparation of Coin Cells with Half-Cell Configuration:

Coin cells were fabricated using lithium titanates (described in Examples 2, 9, 11, and 14). A paste was prepared by mixing 80 parts of lithium titanate, 10 parts of polyvinylidene fluoride (PVDF) (13 wt % in N-methylpyrrolidone, KurehaAmerica Corp., New York, N.Y., #9130) as a binder, and 10 parts of Super C65 carbon black (Timcal Ltd., Westlake, Ohio) as a conductive material by weight in N-methylpyrrolidone (NMP, anhydrous, Sigma-Aldrich) solvent. Lithium titanate was mixed with the carbon black using a SPEX® mixer (SPEX® SamplePrep®, LLC., Metuchen, N.J.) for 30 min; then, NMP was added to wet the dry powders and PVDF was added, followed by mixing in a Thinky mixer (Thinky USA, Inc., Laguna Hills, Calif.) for 1 min. The final paste was made by mixing in the SPEX® mixer for 1 h.

The paste was cast using a doctor blade (5 mils gate, Precision Gage & Tool Co., Dayton, Ohio) onto Cu foil (18 μm, Oak-Mitisui Corp., Japan) The resulting electrode was dried at 120° C. under nitrogen flow for 30 min, and under vacuum overnight. The dried electrode was pressed in a homemade calendar with a nip force of 540 lbs (2.40 kN) at ambient temperature. The electrode was punched into disks with a diameter of 13 mm using a HSNG-EP punch (Hohsen Co., Japan). The electrode disks were dried in a glove box transfer chamber at 120° C. and vacuum for 10 h and then transferred to a glove box for coin cell assembly.

Lithium-ion CR2032 coin cells in half-cell configuration were fabricated using a lithium titanate electrode disk as working electrode, Li foil (diameter 15 mm, thickness 750 μm, Alfa Aesar, Ward Hill, Mass.) as counter electrode, Celgard 2325 or 2500 (diameter 16.8 mm, Celgard, LLC., Charlotte, N.C.) as separator and 1.0 M LiPF₆ in 30 parts of ethylene carbonate and 70 parts of diethylene carbonate by volume as electrolyte. Celgard 2500 was used as the separator for the coin cell prepared with the lithium titanate described in Example 14 and Celgard 2325 was used for the other coin cells. The coin cell parts (case, spacers, wave spring, gasket, and lid) and coin cell automatic crimper were obtained from Hohsen Corp (Osaka, Japan).

The coin cells were tested in the operation voltage range from 1.0 V to 2.5 V with the same charging/discharging rates, i.e., 0.1 C, 1 C, 5 C, and 10 C rates. Table 1 lists the surface areas of the various lithium titanates tested and their charging (delithiation) capacities at 0.1 C, 1 C, 5 C, and 10 C rates.

TABLE 1
Performance of Coin Cells Prepared
with Various Lithium Titanates

| Lithium | BET surface | Discharge Capacity (mAh/g) | | | |
|---|---|---|---|---|---|
| Titanate | area (m²/g) | 0.1 C | 1 C | 5 C | 10 C |
| Example 2 | 3.7 | 165 | 158 | 119 | 84 |
| Example 9 | 6.6 | 165 | 162 | 149 | 128 |
| Example 11 | 5.9 | 168 | 163 | 139 | 112 |
| Example 14 | 6.0 | 174 | 172 | 160 | 144 |

As shown by the data in Table 1, the process disclosed herein produced lithium titanate having a surface area less 10 m²/g. Coin cells prepared using electrodes containing the lithium titanates prepared by the process disclosed herein (Examples 2, 9, 11, and 14) exhibited good electrochemical performance in terms of discharge capacity at high C-rates (i.e., 1 C to 10 C).

What is claimed is:

1. A process for preparing Li₄Ti₅O₁₂, comprising the steps of:
a) hydrolyzing TiCl₄ in an aqueous medium to provide an aqueous solution containing TiOCl₂ at a concentration of about 0.1 M to about 3.0 M;
b) generating a suspension containing hydrated TiO₂ particles by preparing a reaction mixture having a Ti concentration of about 0.05 M to about 2.0 M by adding the aqueous solution containing TiOCl₂ to a volume of a second aqueous medium which is agitated and heated to a temperature of about 60° C. to about 100° C., wherein the aqueous solution containing TiOCl₂ is added to the second aqueous medium at a rate less than 40 mL/L/min; and continuing agitating and heating the reaction mixture at a temperature of about 60° C. to about 100° C. for a period of time sufficient to prepare the suspension containing hydrated TiO₂ particles, wherein the hydrated TiO₂ particles have a median diameter of about 0.1 μm to about 9.0 μm;
c) recovering the hydrated TiO₂ particles from the suspension of step (b);
d) mixing the hydrated TiO₂ particles with a lithium salt to prepare a mixture having a Li to Ti ratio of about 0.6 to about 1.0; and
e) calcining the mixture from step (d) at a temperature of about 750° C. to about 1000° C. for a period of time sufficient to prepare Li₄Ti₅O₁₂.

2. The process of claim 1, wherein the aqueous medium in step (a) is maintained at a temperature of about −20° C. to about 20° C.

3. The process of claim 1, wherein the aqueous medium in step (a) is maintained at a temperature of about −5° C. to about 5° C.

4. The process of claim 1, wherein the concentration of TiOCl₂ in the aqueous solution in step (a) is about 1.0 M to about 2.5 M.

5. The process of claim 1, wherein the reaction mixture of step (b) has a Ti concentration of about 0.5 M to about 1.5 M.

6. The process of claim 1, wherein the second aqueous medium of step (b) is heated to a temperature of about 80° C. to about 100° C.

7. The process of claim 1, wherein the second aqueous medium of step (b) is agitated at a rate to give turbulent flow.

8. The process of claim 1, wherein the aqueous solution containing TiOCl₂ is added to the second aqueous medium at a rate of about 1.0 mL/L/min to about 10 mL/L/min.

9. The process of claim 1, wherein the mixture of Step (d) has a Li to Ti ratio of about 0.7 to about 0.9.

10. The process of claim 1, wherein the lithium salt is selected from the group consisting of lithium hydroxide, lithium carbonate, lithium sulfate, lithium phosphate, lithium carboxylates, and mixtures thereof.

11. The process of claim 10, wherein the lithium salt is lithium carbonate.

12. The process of claim 1, wherein the calcining of step (e) is at a temperature of about 750° C. to about 900° C.

13. The process of claim 1, wherein the Li₄Ti₅O₁₂ has a purity greater than 95% and a surface area greater than or equal to 3.0 m²/g.

14. A process for preparing titanium dioxide, comprising the steps of:
a) hydrolyzing TiCl₄ in an aqueous medium to provide an aqueous solution containing TiOCl₂ at a concentration of about 0.1 M to about 3.0 M;
b) generating a suspension containing hydrated TiO₂ particles by preparing a reaction mixture having a Ti concentration of about 0.05 M to about 2.0 M by adding the aqueous solution containing TiOCl₂ to a volume of a second aqueous medium which is agitated and heated to a temperature of about 60° C. to about 100° C., wherein the aqueous solution containing TiOCl₂ is added to the second aqueous medium at a rate less than 40 mL/L/min; and continuing agitating and heating the reaction mixture at a temperature of about 60° C. to about 100° C. for a period of time sufficient to prepare the suspension containing hydrated TiO₂ particles, wherein the hydrated TiO₂ particles have a median diameter of about 0.1 μm to about 9.0 μm; and
c) recovering the hydrated TiO₂ particles from the suspension of step (b).
